(19) United States
(12) Patent Application Publication
(10) Pub. No.: US 2016/0372297 A1
(43) Pub. Date: Dec. 22, 2016

(54) Systems and Methods for Generating Tunable Electromagnetic Waves Using Carbon Nanotube-Based Field Emitters

(71) Applicant: California Institute of Technology, Pasadena, CA (US)

(72) Inventors: Harish Manohara, Arcadia, CA (US); Risaku Toda, Glendale, CA (US); Mohammad M. Mojarradi, La Canada, CA (US); Linda Y. Del Castillo, Irvine, CA (US)

(73) Assignee: California Institute of Technology, Pasadena, CA (US)

(21) Appl. No.: 15/187,659

(22) Filed: Jun. 20, 2016

Related U.S. Application Data
(60) Provisional application No. 62/181,894, filed on Jun. 19, 2015.

(51) Int. Cl. H01J 35/06; H01J 35/08

(52) U.S. Cl. CPC H01J 35/065; H01J 35/08; H01J 2235/081

(57) ABSTRACT

Systems and methods in accordance with embodiments of the invention generate tunable electromagnetic waves using carbon nanotube-based field emitters. In one embodiment, a CNT-based irradiator includes: at least one CNT-based cathode, itself including: a plurality of carbon nanotubes adjoined to a substrate; a plurality of anodic regions; where each anodic region is configured to emit a distinctly different class of photons in a direction away from the at least one cathode in response to a same reception of electrons; where each of the plurality of anodic regions is operable to receive electrons emitted from at least one of said at least one CNT-based cathode; and where each of the at least one CNT-based cathode and the plurality of anodic regions are disposed within a vacuum encasing.

### CROSS-REFERENCE TO RELATED APPLICATIONS

The current application claims priority to U.S. Provisional Application No. 62/181,894, filed Jun. 19, 2015, the disclosure of which is hereby incorporated by reference in its entirety.

### STATEMENT OF FEDERAL FUNDING

The invention described herein was made in the performance of work under a NASA contract NNN12AA01C, and is subject to the provisions of Public Law 96-517 (35 USC 202) in which the Contractor has elected to retain title.

### FIELD OF THE INVENTION

The present invention generally relates to generating tunable electromagnetic waves using carbon nanotube-based field emitters.

### BACKGROUND

X-ray computed tomography (X-ray CT) refers to a non-destructive inspection technique that generally involves irradiating a target with X-rays to produce three-dimensional representations of the scanned target. Typically, the target is irradiated with the X-rays, and the response (e.g. backscatter or transmission through the target) is detected, characterized, and thereby used in analyzing the structure of the target.

### SUMMARY OF THE INVENTION

Systems and methods in accordance with embodiments of the invention generate tunable electromagnetic waves using carbon nanotube-based field emitters. In one embodiment, a CNT-based irradiator includes: at least one CNT-based cathode, itself including: a plurality of carbon nanotubes adjoined to a substrate; a plurality of anodic regions; where each anodic region is configured to emit a distinctly different class of photons in a direction away from the at least one cathode in response to a same reception of electrons; where each of the plurality of anodic regions is operable to receive electrons emitted from at least one of said at least one CNT-based cathode; and where each of the at least one CNT-based cathode and the plurality of anodic regions are disposed within a vacuum encasing.

In another embodiment, at least one of the plurality of anodic regions includes one of: Copper, Cobalt, Molybdenum, Tungsten, Palladium, Tantalum, Platinum, and Gold.

In yet another embodiment, each of the plurality of anodic regions is configured to emit a distinctly different class of photons corresponding with the X-ray portion of the electromagnetic spectrum in a direction away from the at least one cathode in response to a same reception of electrons.

In still yet another embodiment, each of the distinctly different classes of photons are distinctly different as measured by the respective characteristic K_{α} lines.

In a further embodiment, the plurality of carbon nanotubes are in the form of bundles of carbon nanotubes that are between approximately 1 μm and approximately 2 μm in diameter and that are spaced apart at a distance of approximately 5 μm.

In a still further embodiment, the plurality of anodic regions define a contiguous anode.

In a yet further embodiment, the contiguous anode is rotatable such that each of the plurality of anodic regions can be placed within the line of sight of at least one of said at least one CNT-based cathode.

In a still yet further embodiment, the plurality of anodic regions define a contiguous circular anode.

In another embodiment, the plurality of anodic regions define quadrants within the contiguous circular anode.

In yet another embodiment, the plurality of anodic regions define a pyramidal shape.

In still another embodiment, a CNT-based irradiator further includes: a first gate electrode configured to accelerate electrons emitted from at least one of said at least one CNT-based cathode; and a second gate electrode configured to focus electrons emitted from at least one of said at least one CNT-based cathode relative to at least one of the plurality of anodic regions.

In still yet another embodiment, a CNT-based irradiator further includes a beam steering device operable to steer electrons emitted from at least one of said at least one CNT-based cathode towards a selected one of the plurality anodic regions in a first mode and a selected different one of the plurality of anodic regions in a second mode.

In a further embodiment, the beam steering device is in the form of focusing coils.

In a yet further embodiment, the at least one CNT-based cathode is at least two CNT-based cathodes.

In a still further embodiment, each of the CNT-based cathodes is independently operable such that a first CNT-based cathode can be operating to emit electrons while a second CNT-based cathode is not emitting electrons.

In a still yet further embodiment, each of at least two CNT-based cathodes is operable to simultaneously emit electrons towards a different respective one of the plurality of anodic regions.

In another embodiment, the anodic regions are configured such that each of at least two anodic regions can emit a distinctly different class of photons in a same general direction in response to the reception of electrons.

In still another embodiment, at least one anodic region is operable to emit a distinctly different class of photons causing the propagation of electromagnetic waves in a planar manner 360° outside of the vacuum encasing.

In yet another embodiment, a CNT-based irradiator includes: at least one CNT-based cathode, itself including: a plurality of carbon nanotubes adjoined to a substrate; at least one anodic region comprising an alloy and thereby configured to generate multispectral output in response to the reception of electrons; where at least one of the at least one anodic region is operable to receive electrons emitted from at least one of the at least one CNT-based cathode; where the at least one CNT-based cathode and the at least one anodic region are disposed within a vacuum encasing.

In still yet another embodiment, the at least one anodic region is operable to emit distinctly different classes of photons corresponding with the X-ray portion of the electromagnetic spectrum as determined by respective characteristic K_{α} lines.

### BRIEF DESCRIPTION OF THE DRAWINGS

FIG. 1 illustrates tomography with respect to a geological formation in accordance with certain embodiments of the invention.

FIG. 2 illustrates a tunable CNT-based irradiator, and its operation, in accordance with certain embodiments of the invention.

FIGS. 3A-3B illustrate a carbon nanotube configuration and corresponding data for carbon nanotubes that can be implemented in accordance with certain embodiments of the invention.

FIG. 4 illustrates a typical X-ray source spectrum that can be achieved in accordance with certain embodiments of the invention.

FIGS. 5A-5C illustrate simulated X-ray source spectra for a tungsten anodic region that can be achieved in accordance with certain embodiments of the invention.

FIGS. 6A-6B illustrate a tunable CNT-based irradiator that includes a rotatable anode having different anodic regions characterized by different emission spectra in accordance with certain embodiments of the invention.

FIGS. 7A-7B illustrate a tunable CNT-based irradiator that includes focusing coils that can steer emitted electrons to regions of the anode characterized by different emission spectra in accordance with certain embodiments of the invention.

FIG. 8 illustrates a tunable CNT-based irradiator including anodic regions defining a conical shape in accordance with certain embodiments of the invention.

FIG. 9 illustrates a tunable CNT-based irradiator including a plurality of cathodes in accordance with certain embodiments of the invention.

FIG. 10 illustrates a tunable CNT-based irradiator incorporating individually controllable cathodes in accordance with certain embodiments of the invention.

FIG. 11 illustrates a tunable CNT-based irradiator operable to simultaneously emit distinctly different electromagnetic waves in a same direction in accordance with certain embodiments of the invention.

FIG. 12A-12D illustrate examples of distinctly different spectra that can be realized in accordance with embodiments of the invention.

### DETAILED DESCRIPTION

Turning now to the drawings, systems and methods for generating tunable electromagnetic waves using carbon nanotube-based field emitters are illustrated. As can be appreciated, X-ray CT techniques have widespread applications. For example, such techniques can find use in: medical imaging, nondestructive materials analyses, and reverse engineering. Importantly, they can also be used in the context of geological exploration and excavation (including in the context of extraterrestrial planetary subsurface geological formation analysis). Such geological survey information can be particularly useful in the oil and gas industry. Indeed, the conventional notion of “Logging While Drilling” references acquiring respective geological formation information while boring into the Earth (e.g. to establish an oil well). For instance, such geological formation information can include: formation density, porosity, permeability, and low-resolution indirect images of the surrounding formation. In some instances, to provide high-resolution information concerning a respective geological formation, Caesium-137 has been used to implement compositional analysis; specifically, Caesium-137 can emit gamma rays and thereby provide compositional analysis. However, Caesium-137 is radioactive, and this generally undesirable characteristic can limit its real-world viability. In many instances, it is desirable to be able to provide tomography and other structural analysis without having to rely on radioactive components.

Carbon nanotubes (CNTs) have many exceptional properties that make them attractive for a variety of applications. For instance, CNTs are amongst the strongest materials, as measured by tensile strength, and amongst the stiffest materials, as measured by elastic modulus. Additionally, CNTs have also been determined to possess outstanding electrical ‘field emission’ properties, with high emission currents at low electric field strengths (e.g., applied field from 1-3 V/μm and an emission current ˜0.1 mA from a single nanotube, as measured in conventional configurations). For context, field electron emission generally regards the emission of electrons, e.g. from a solid surface into a vacuum, based on the influence of an electric field. Field electron emission is relied on in a number of applications including microscopy, spectroscopy, and display technology. In any case, CNTs have demonstrated viability as cold-cathode field emission sources, especially for applications requiring high current densities (e.g. hundreds to thousands of amperes per cm²) and lightweight packages (high frequency vacuum tube sources).

Indeed, in U.S. patent application Ser. No. 11/137,725 (issued as U.S. Pat. No. 7,834,530—the “530 patent”), Manohara et al. disclose particular configurations for a high density carbon nanotube-based field emitter that provide favorable performance characteristics. For example, Manohara et al. disclose that field emitters that include a plurality of bundles of CNTs disposed on a substrate, where the diameter of the bundles is between approximately 1 μm and approximately 2 μm, and where the bundles of CNTs are spaced at a distance of approximately 5 μm from one another, demonstrate particularly advantageous performance characteristics. The '530 patent is hereby incorporated by reference in its entirety, especially as it pertains to the aforementioned configurations.

Nonetheless, even though CNT-based field emitters have been proposed and developed, in many instances, these field emitters have been deficient in some respects. For example, in many previous instances, the CNTs were not sufficiently bonded to the underlying substrate. For instance, in many cases, when the field emitters were subject to an electric field during operation, the electric field would cause at least some of the carbon nanotubes to detach from the substrate. In some instances, it was determined that pressures as light as between approximately 20 kPa and approximately 60 kPa were sufficient to detach CNTs from the underlying substrate. Thus, gently rubbing the surface of the substrate of these field emitters with a Q-tip could have been sufficient to dislodge CNTs from the substrate. This fragility can be problematic. For example, the field emission performance of the field emitter can degrade as a function of the number of detached CNTs. Moreover, detached CNTs can potentially short circuit associated circuitry. In essence, the weak bond between CNTs and associated substrates of these CNT-based field emitters can undermine their potential to serve as robust field emitters that can withstand rigorous operating conditions. To address this issue, in U.S. patent application Ser. No. 14/081,932 (issued as U.S. Pat. No. 9,064,667—“the '667 patent”), Manohara et al. disclose particular methods for better adhering CNTs to a respective underlying substrate. For example, the '667 patent discloses heating the substrate so as to soften it and thereby allow a plurality of the CNTs to become at least partially enveloped by the softened substrate. The disclosure of the '667 patent is hereby incorporated by reference in its entirety, especially as it regards methods enabling the substrate to envelop at least a portion of a plurality of CNTs.

Against this backdrop, many embodiments of the invention utilize CNT-based field emitters to generate tunable electromagnetic waves, e.g. that can be used to implement radiography. In many embodiments, a CNT-based field emitter is implemented in conjunction with a selectable metallic anodic region; the emission of electrons towards a selected anodic region can result in the generation of electromagnetic waves. Importantly, by modulating the potential difference applied to cause CNT field emission and causing electrons to be emitted towards a particular metallic anodic region, electromagnetic waves of a desired frequency range (e.g. X-rays), intensity, and characteristic values can be achieved. As can be appreciated, such ‘irradiators’ can be used in conjunction with detection devices to achieve radiography. In this way, versatile non-radioactive irradiators can be achieved. CNT-based radiography techniques are now described in greater detail below.

### CNT-Based Radiography

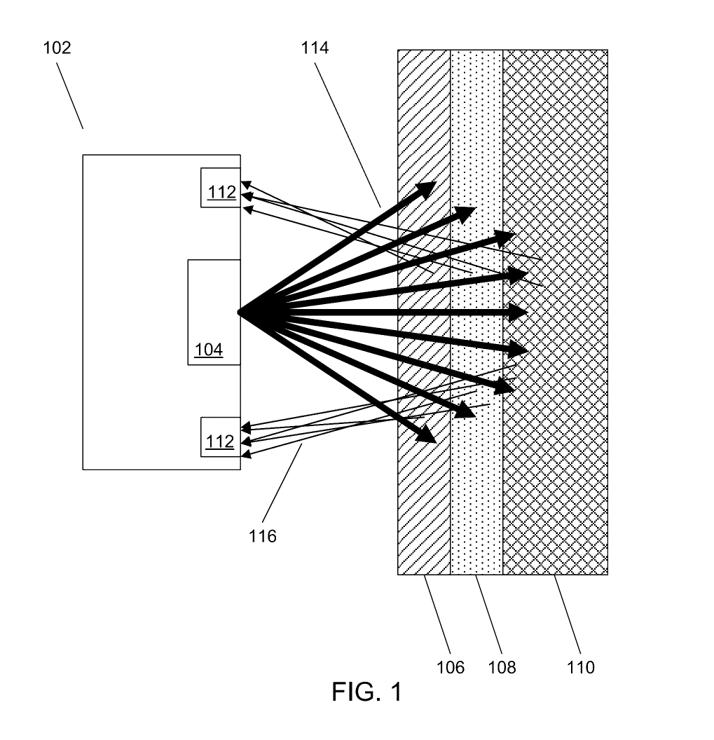

In many embodiments of the invention, irradiators that include CNT-based field emitters are implemented; such ‘CNT-based irradiators’ can be implemented in radiography. Within the context of the instant application, an Irradiator′ can generally be understood to be a source of electromagnetic energy, e.g. it can radiate electromagnetic waves. For purposes of context, FIG. 1 schematically illustrates using a CNT-based irradiator in accordance with certain embodiments of the invention to implement a tomographic device used to analyze a geological formation. In particular, FIG. 1 illustrates that a tomographic device 102 includes a CNT-based irradiator 104 in conjunction with two detection devices 112. In FIG. 1, the tomographic device 102 is disposed within a pipe 106 and is being used to analyze an adjacent geological formation 110; a cement structure 108 separates the pipe 108 from the geological formation. In this context, the tomographic device 102 generally functions by using the CNT-based irradiator to emit electromagnetic waves—in this case, X-rays 114—characterized by a certain energy and intensity range in the direction of the formation to be analyzed. In accordance with principles of radiography, the interaction of the X-rays 114 with the various solid structures (e.g. the pipe 106, the cement structure 108, and the geological formation 110) can produce tackscatter 116, which references the radiation that reflects from the target in response to the incident X-ray radiation. This backscatter 116 can be detected by the detectors 112 and analyzed to infer the information concerning the structure of the geological formation 110. Of course, while using a CNT-based irradiator 104 in the context of analyzing a geological formation 110 is illustrated, CNT-based irradiators can be implemented in any suitable context in accordance with embodiments of the invention. As mentioned above, tomographic techniques can be implemented in a variety of applications (e.g. medical imaging, non-destructive materials analyses, and/or reverse engineering); correspondingly, CNT-based irradiators in accordance with many embodiments of the invention can be used in suitable such applications.

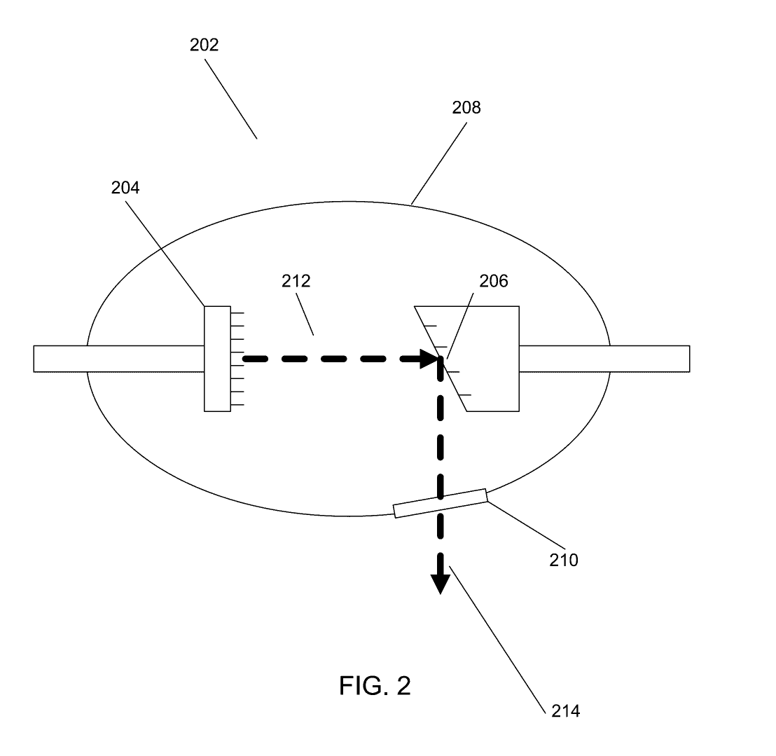

FIG. 2 illustrates the general structure of a CNT-based irradiator in accordance with many embodiments of the invention, as well as the generally understood operating mechanics. In particular, it is illustrated that the CNT-based irradiator 202 includes a CNT-based cathode 204 and a plurality of anodic regions 206, both of which are disposed within a vacuum chamber 208, which includes a window 210 through which electromagnetic waves 210 can be emitted. Each of the plurality of anodic regions is configured to respond differently to electron reception. For example, each of the anodic regions can produce distinctly different electromagnetic spectra in response to the reception of electrons. In response to a potential difference, the CNT-based cathode 204 (which also can be understood as a CNT-based field emitter) emits electrons 212, which are directed at a respective anodic region 206. In turn, the respective anodic region 206 reacts to the bombardment of electrons by reflecting photons 214 that have a characteristic wavelength, frequency, energy, and intensity. Importantly, by modulating the potential difference used to cause the field emission and the anodic material that emits the photons in response to the electron bombardment, the characteristic wavelength, frequency, energy, and intensity can be tuned. In other words, the source spectra can be tuned. As can be appreciated, this tunability can beneficially improve tomography. For example, the source spectra can be tuned so as to penetrate the target at deeper levels, e.g. such that analysis can be obtained concerning the deeper level.

FIG. 2 further illustrates the general operation of an irradiator in accordance with an embodiment of the invention. In particular, FIG. 2 illustrates that the irradiator includes a carbon nanotube-based field emitter 204 (acting as a cathode) and a corresponding plurality of anodic regions 206. Note that the carbon nanotube-based field emitter 204 and the anodic regions 206 are disposed within a single vacuum envelope. Based on the application of a potential difference, electrons are emitted 212 off of the carbon nanotube cathode 204 toward a respective anodic region 206; the receipt of the electrons by the respective anodic region 206 causes photons to be emitted 214 off of the anodic region. By using a proper potential difference and a proper target anodic region, the photons can be controlled so that they correspond with desired electromagnetic radiation, e.g. X-rays. Note that in the illustrated embodiment, a window 210 is included that can allow the electromagnetic radiation to pass through and irradiate a desired target.

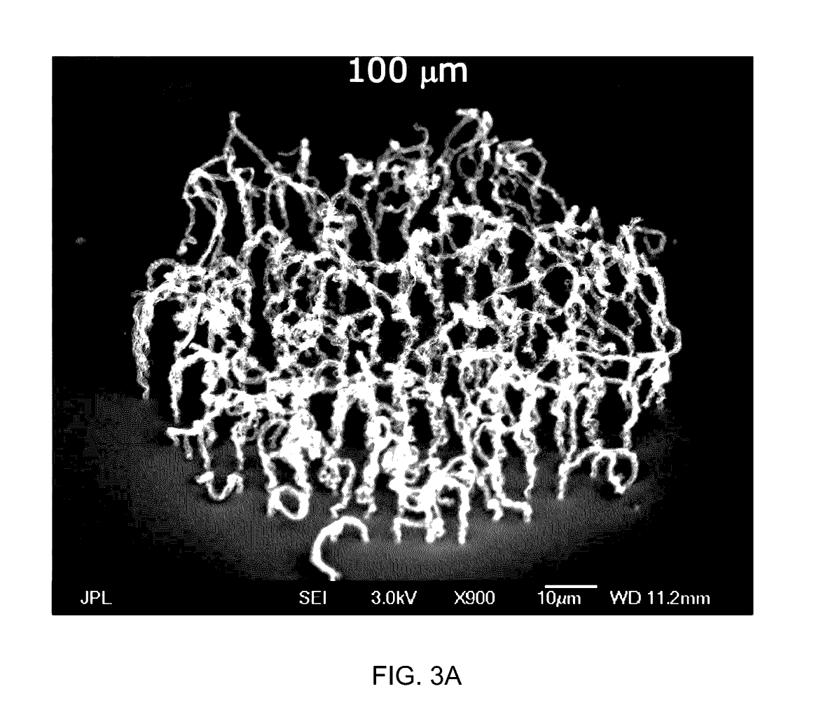

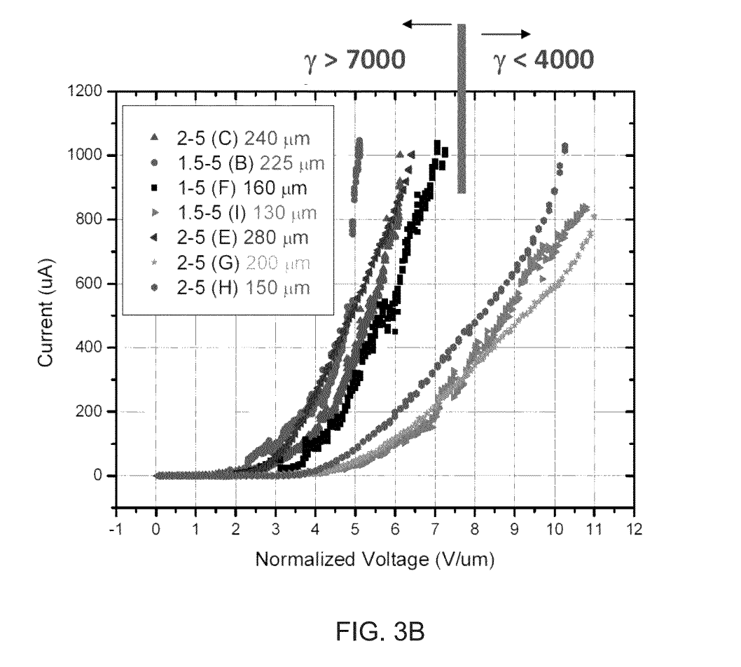

Importantly, any suitable CNT-based field emitter can be implemented in accordance with embodiments of the invention. For example, any of the CNT-based field emitters described in the '530 patent and/or the '667 patent can be implemented in accordance with embodiments of the invention. Thus, for instance FIG. 3A illustrates an SEM image of a carbon nanotube configuration that can be implemented to form a carbon nanotube-based field emitter in accordance with certain embodiments of the invention. In particular, the depicted configuration is approximately 100 μm in diameter, and includes bundles of carbon nanotubes that are approximately between 1 μm diameter and approximately 2 μm diameter. Additionally, in the illustrated configuration, the bundles of carbon nanotubes are spaced apart by approximately 5 μm and have a height of between approximately 10 μm and approximately 20 μm. Through testing, it was determined that the described configuration can provide a range of current density between approximately 10 A/cm² and approximately 15 A/cm². FIG. 3B illustrates the performance characteristics that CNT-based cathodes can achieve, thereby demonstrating the practicability of CNT-based cathodes.

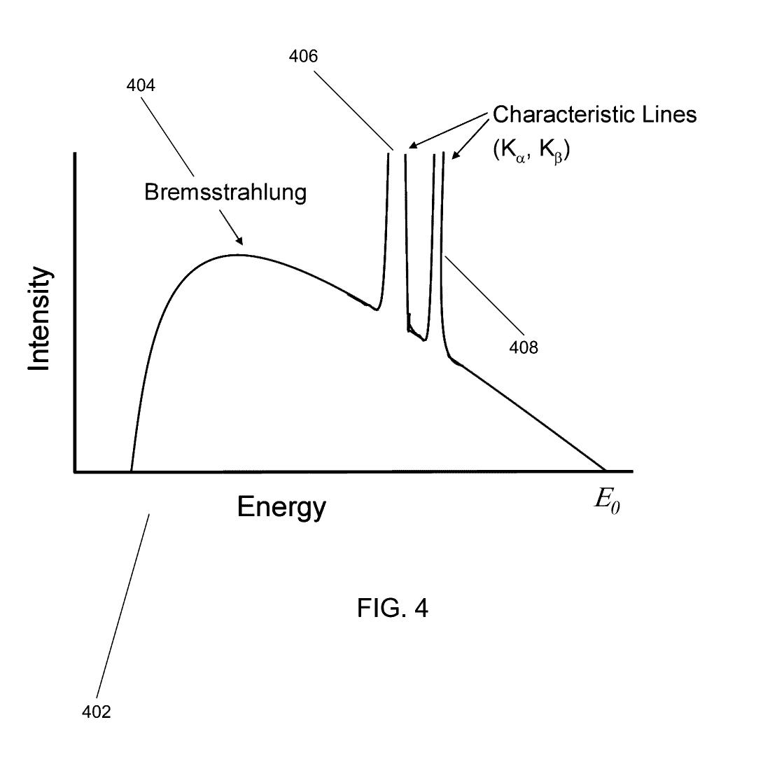

FIG. 4 illustrates a typical X-ray source spectrum that can result in accordance with certain embodiments of the invention. In particular, it is depicted that the spectrum 402 includes a Bremsstrahlung region 404, a first characteristic line K_{α} 406, and a second characteristic line K_{β} 408. In many instances in radiography, it is the characteristic lines K_{α} and K_{β} that are of significance. For instance, the K_{α} and K_{β} can implicate the X-ray penetration ability. Accordingly, in many embodiments of the invention, the X-ray spectrum is tuned to adjust the K_{α} and K_{β} characteristics. As alluded to previously, the emitted electromagnetic spectra can be a function of the potential difference used in the field emission as well as a function of the particular anodic material absorbing the electrons and emitting photons.

Accordingly, the anodic regions 206 can comprise any suitable combination of materials in accordance with embodiments of the invention. In many embodiments, the anodic material that the electrons are ‘aimed’ toward is selectable such that the corresponding electromagnetic spectrum can be adjusted. For instance, in many embodiments, the anode includes portions made from discretely different elements associated with discretely different emission spectra, and the orientation of the CNT-based cathode and the anode can be adjusted such that the electrons can be emitted toward a desired one of the discrete elements. For example, where the anodic regions correspond with the emission of X-ray spectra, the distinctly different emission spectra can be characterized by discretely different characteristic K_{α} lines. Since the discretely different elements are associated with discretely different emission spectra, the irradiator can be tuned by ‘aiming’ the CNT cathode towards a respective desired element.

Table 1 below lists data relating to X-ray source spectra plots for various metallic anodic regions that can be implemented in accordance with embodiments of the invention.

| | K_{α} Energy | Min. Power Supply |
|---|---|---|
| Targets | (keV) | Requirement (kV) (~2x) |
| Cobalt | 6.930 | 14 |
| Copper | 8.048 | 16 |
| Molybdenum | 17.479 | 35 |
| Palladium | 21.177 | 40 |
| Tantalum | 57.532 | 115 |
| Tungsten | 59.318 | 120 |
| Platinum | 66.832 | 130 |
| Gold | 68.804 | 140 |

In particular, Table 1 lists the K_{α} levels associated with anodes made from various materials, as well as an applied potential difference that can result in the stated K_{α} level.

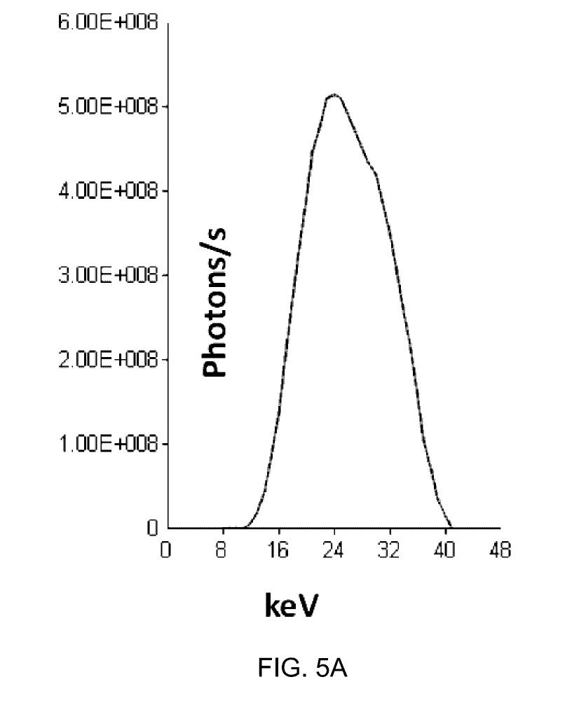

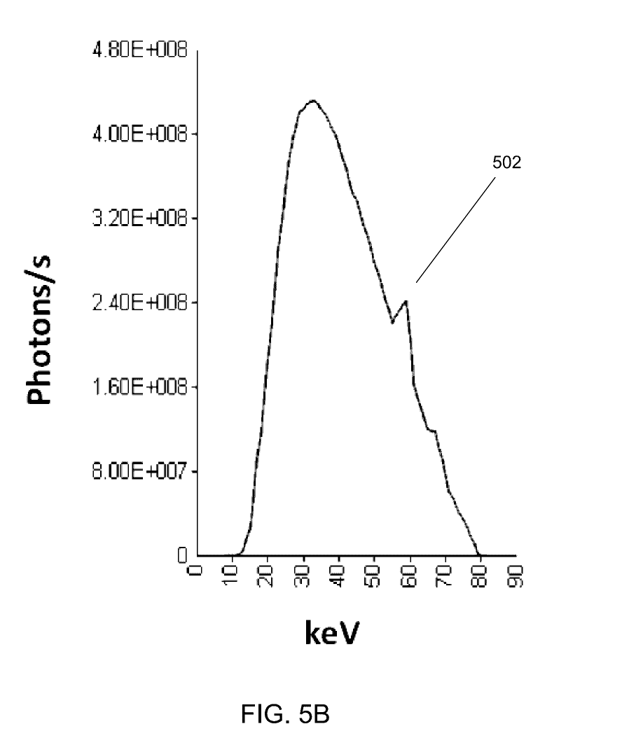

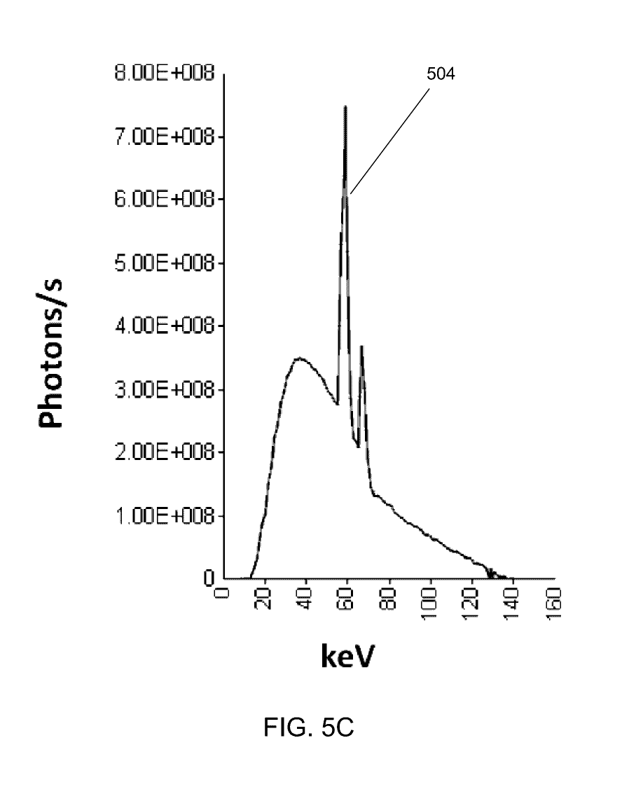

FIGS. 5A-5C depict simulated spectra plots for a Tungsten anode, and illustrate how the desired K_{α} line emerges upon the anode being supplied with a requisite energy. In particular, FIG. 5A illustrates the simulated X-ray source spectrum for a Tungsten anode corresponding with the application of a potential difference of 40 kV. Note that no K_{α} line is visible. FIG. 5B illustrates the simulated X-ray source spectrum for a Tungsten anode corresponding with the application of a potential difference of 80 kV. In this plot, it is depicted that the characteristic K_{α} line 502 is beginning to emerge. FIG. 5C illustrates the simulated X-ray source spectrum for a Tungsten anode corresponding with the application of a potential difference of 120 kV. In this plot, it is depicted that the characteristic K_{α} line 504 is fully developed. In general, it is seen that by varying the particular metallic anodic region and the applied potential difference, the resulting electromagnetic source spectra can be controlled. As can be appreciated, this level of control can be beneficially used, e.g., in the context of tomography. Moreover, although the above description has been presented with respect to tomography, the same techniques can be used to obtain elemental composition information; in particular, the described tunability can enable this possibility.

Nevertheless, it is seen that CNT-based irradiators that can radiate tunable electromagnetic waves can be implemented. Various structures for such irradiators are now described.

### Structures for Tunable CNT-Based Irradiators

In many embodiments of the invention, tunable CNT-based irradiators are implemented. As can be appreciated from the above discussion, such irradiators can be implemented for the purposes of tomography and/or elemental composition analysis. Importantly, these tunable CNT-based irradiators can be implemented in any of a variety of configurations in accordance with embodiments of the invention. In many embodiments, an irradiator includes a CNT cathode and a plurality of anodic regions that are all disposed within a vacuum sealed enclosure. As mentioned previously, the potential difference applied to cause field emission as well as the anodic region that the electrons are directed towards can be modulated to control the emission spectra. In many embodiments, the irradiator further includes gates that can augment the operation of the irradiator.

The plurality of anodic regions can be realized in any of a variety of ways in accordance with embodiments of the invention. For example, in many embodiments of the invention, the anodic regions are contiguous with one-another, with each anodic region being characterized by discretely different emission spectra. The irradiator is configured such that the electrons emitted from the CNT-based cathode can be targeted towards one of the desired anodic regions; in this way the resulting emission spectra can be controlled. This can be achieved using any of a variety of configurations in accordance with embodiments of the invention. For example, in some embodiments, the anodic regions are contiguous and define a circular face, with each anodic region defining a different surface area—e.g. a quadrant—within the circular face. Moreover, the ‘circular face’ is capable of being rotated such that each quadrant can be positioned within the line of sight of the emitted electrons.

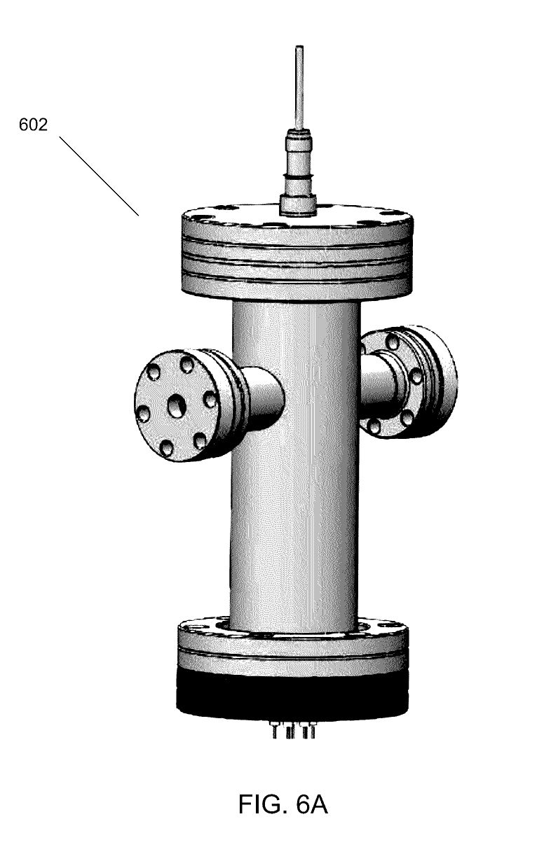

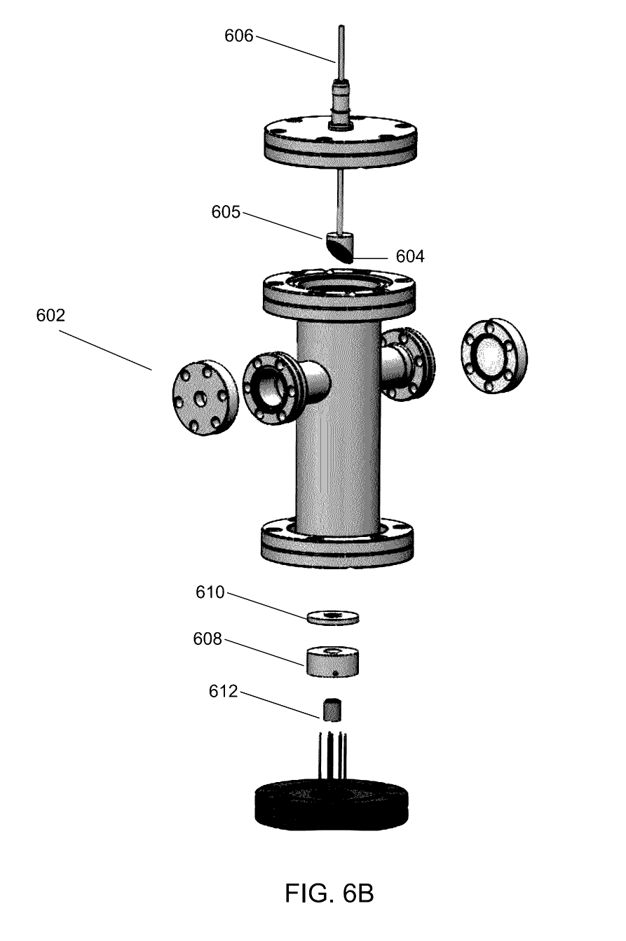

FIGS. 6A-6B illustrate an irradiator that includes a plurality of anodic regions defining quadrants within a rotatable circular face, where each anodic region comprises a different element, and is thereby characterized by different emission spectra. In particular, FIG. 6A depicts the irradiator 602 in an assembled state. FIG. 6B illustrates an exploded view of the irradiator 602. The irradiator 602 includes: a CNT-based cathode 612; a first gate 608; and a second gate 610. In the illustrated embodiment, it is depicted that the anodic regions 604 define quadrants within an angled circular face 605. Each of the four quadrants 604 is comprised of a different material characterized by a different emission spectrum relative to at least one other anodic region. For example the anodic regions 604 can comprise combinations including but not limited to: Copper, Cobalt, Molybdenum, Tungsten, Palladium, Tantalum, Platinum, and/or Gold. Of course, it should be appreciated that the anodic regions 604 can comprise any suitable material in accordance with embodiments of the invention. In many embodiments, at least one anodic region comprises an alloy. In numerous embodiments, at least one anodic region comprises an alloy that is capable of generating multispectral electromagnetic (e.g. X-ray) output. Indeed, in some embodiments, the CNT-based irradiator includes only a single anodic region that includes an alloy capable of generating multispectral electromagnetic output; because a multispectral output can be achieved, the CNT-based irradiator can still provide for a more comprehensive analysis, e.g. within the context of tomography. For example, in some embodiments, the multispectral electromagnetic output includes X-ray spectra having multiple different characteristic K_{α} lines.

The illustrated gates 608, 610 can be used to facilitate the operation of the irradiator. For example, in many embodiments, the gates embody focusing and accelerating devices to focus and accelerate the emitted electrons toward the respective anodic region. For example, in some embodiments, the first gate 608 defines a focusing grid, while the second gate 610 defines an accelerating grid. In general, gates can be used in any suitable way to facilitate the operation of irradiators in many embodiments of the invention.

As can be appreciated, the circular face can be angled so as to ‘aim’ the direction of the reflected/emitted photons. The irradiator 602 further includes an actuating wheel 606 that can be used to rotate the circular face 605 such that it can be determined which particular quadrant 604 of the circular face 605 is within the line of sight of the CNT-based cathode 612. In this way, the emission spectra can be controlled. Of course, it should be appreciated that while an anode having a circular face 605 divided into four quadrants 604 is depicted, the anodic regions 604 can be arranged in any suitable manner in accordance with embodiments of the invention. For example, the anodic regions 604 can define ‘slices’ of any suitable dimension in accordance with certain embodiments of the invention. Moreover, CNT-based irradiators can include any number of anodic regions in accordance with certain embodiments of the invention. Furthermore, the anodic regions do not necessarily have to define a contiguous shape—they can be arranged in any suitable way.

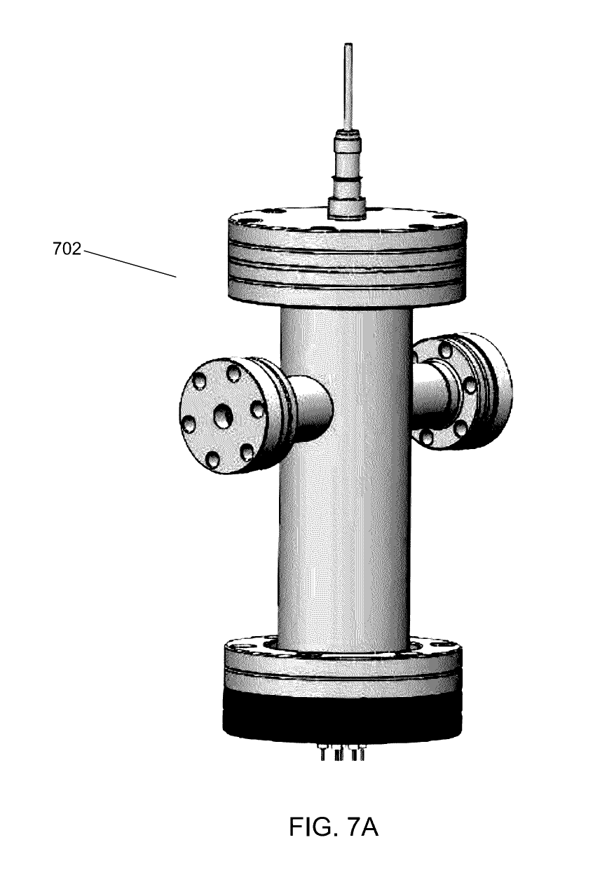

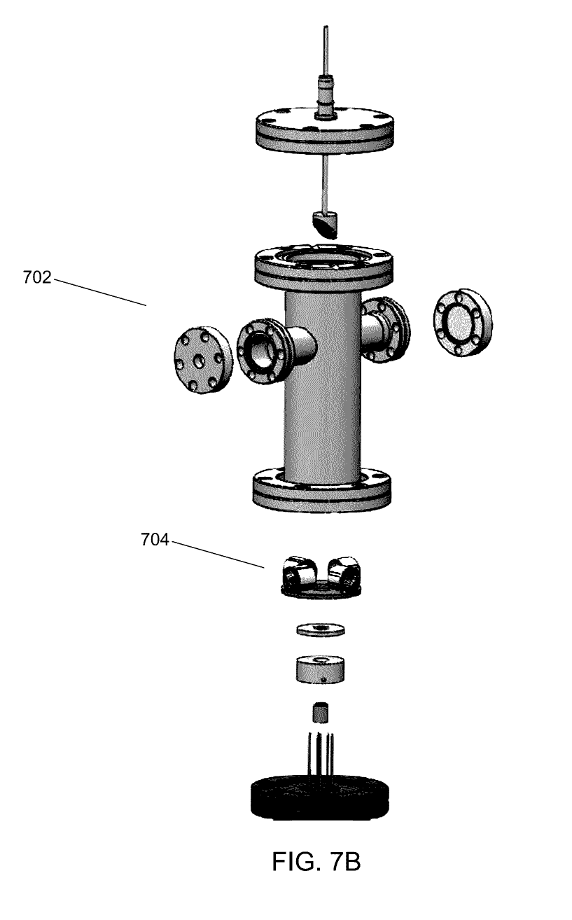

In many embodiments, electrons are emitted towards particular regions of the anode without relying on the repositioning of the anodic regions. For instance, in many embodiments, magnetic steering of the electrons emitted from the cathode is implemented to direct the emitted electrons toward a particular anodic region. Thus for example, FIGS. 7A-7B illustrate an irradiator that includes focusing coils to steer the electrons emitted from the cathode toward a particular anodic region. In particular, the irradiator 702 depicted in FIGS. 7A and 7B is similar to that seen in FIGS. 6A and 6B except that it further includes focusing coils 704 that can steer the beam toward a particular anodic region—each particular region being characterized by a different emission spectrum. In this way, similar to before, the emission spectrum can be controlled. While focusing coils have been illustrated and discussed, it should be made clear that the emitted electrons can be steered using any suitable electron steering device in accordance with embodiments of the invention.

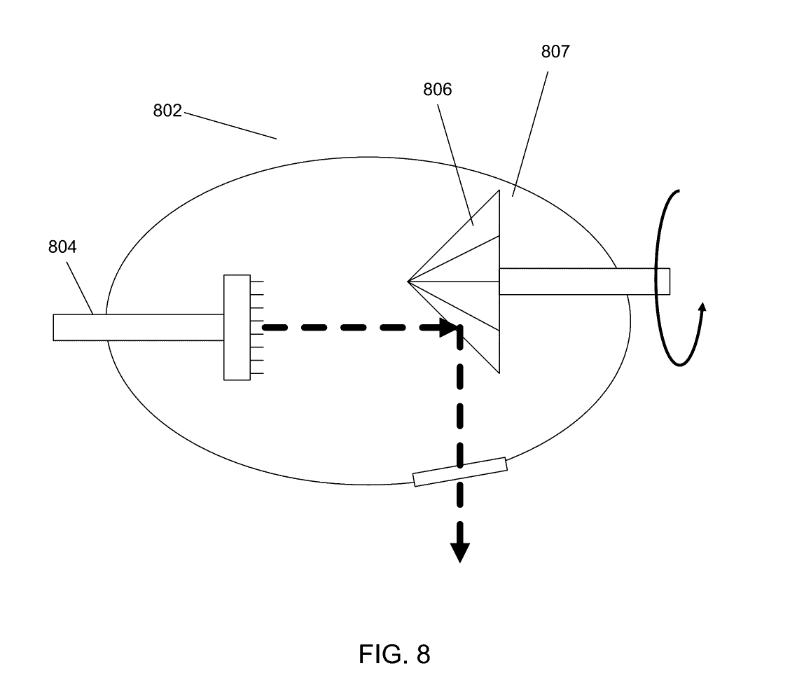

While certain examples of tunable CNT-based irradiator configurations have been given, it should be clear that tunable CNT-based irradiators can be implemented in any of a variety of ways in accordance with embodiments of the invention. For example, in some embodiments, the anodic regions define a pyramidal shape, with each pyramidal face being characterized by a different emission spectra; the pyramidal shape can be rotated to augment which of its faces is in the line of sight of the emitted electrons. Thus, for example, FIG. 8 illustrates a CNT-based irradiator including a single CNT-based cathode and a plurality of anodic regions defining a pyramidal shape. In particular, it is depicted that the CNT-based irradiator 802 includes a CNT-based cathode 804, and a plurality of anodic regions 806 defining a pyramidal shape 807. The pyramidal shape 807 is rotatable so it can be determined which anodic region 806 is within the line of sight of the CNT-based cathode 804.

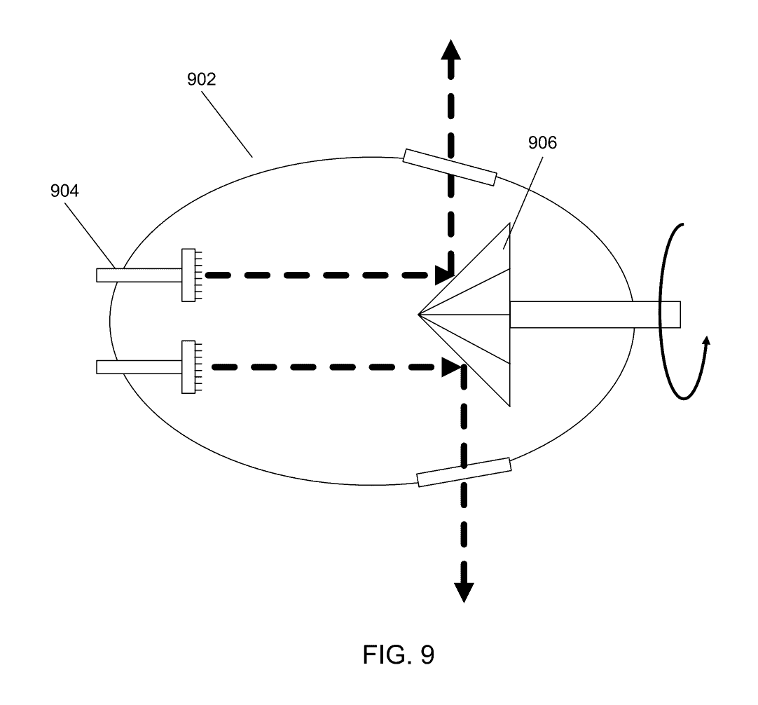

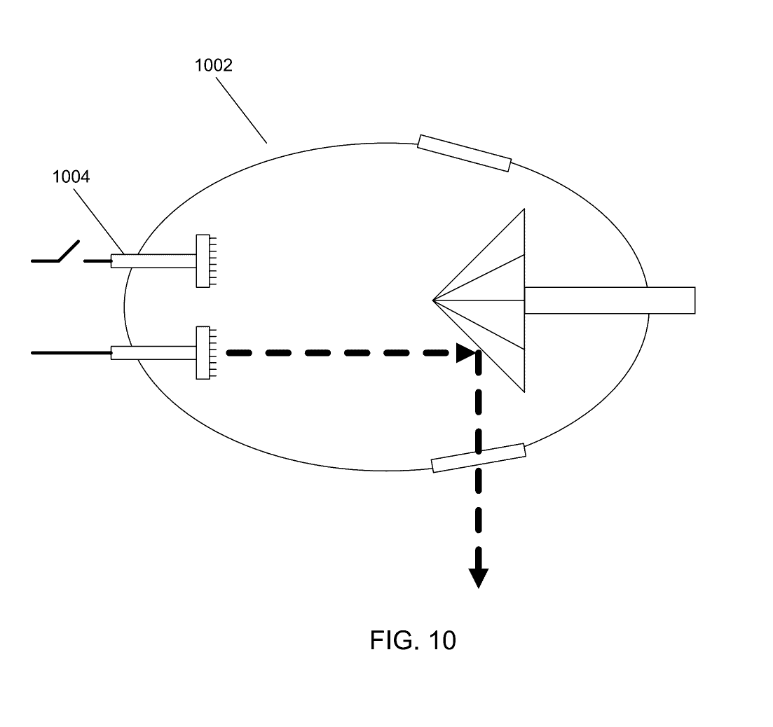

While CNT-based irradiators including a single CNT-based cathode have been depicted, in many embodiments, CNT-based irradiators include a plurality of CNT-based cathodes. This can allow for the simultaneous emission of electromagnetic waves defined by distinctly different characteristics. Thus, for example, FIG. 9 illustrates a CNT-based irradiator including a plurality of CNT-based cathodes that can allow for the simultaneous emission of electromagnetic waves defined by distinctly different characteristics in different directions. In particular, the CNT-based irradiator 902 is similar to that seen in FIG. 8, except that it includes a plurality of CNT-based cathodes 904. Each of the CNT-based cathodes is configured to emit electrons toward a different anodic region 906 (with each anodic region characterized by distinctly different emission characteristics). In this way, the CNT-based irradiator 902 can simultaneously emit electromagnetic waves characterized by distinctly different characteristics. In some embodiments, the anodic regions 906 are rotatable such that different subsets of the anodic regions 906 can be placed within the respective lines of sight of the CNT-based cathodes 904.

In some embodiments, each of a plurality of CNT-based cathodes within an irradiator can be individually powered. In this way, greater control can be exercised over the respective CNT-based irradiator. Thus, for example, FIG. 10 illustrates a CNT-based irradiator including a plurality of CNT-based cathodes that can each be individually powered. In particular, the CNT-based irradiator 1002 is similar to that seen in FIG. 9, except that it is further depicted that each of the cathodes 1004 can be individually powered. In particular, it is illustrated that the ‘top’ cathodes is powered off, while the ‘bottom’ cathode is powered on. As can be appreciated, the ability to individually control each of a plurality of cathodes can enable more refined control of a CNT-based irradiator.

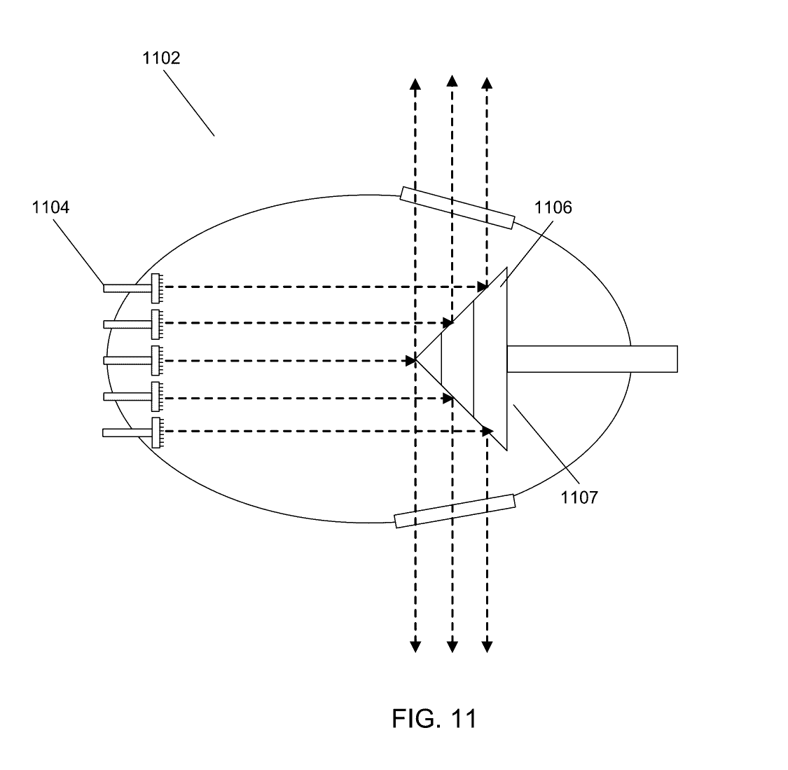

While the above descriptions have regarded CNT-based irradiators that emit electromagnetic spectra defined by different characteristics in different directions, in many embodiments, CNT-based irradiators can be configured to emit electromagnetic spectra having different characteristics in a same direction. Thus, for instance, FIG. 11 illustrates a CNT-based irradiator whereby distinctly different anodic regions are configured to emit distinctly different electromagnetic spectra in substantially the same direction. In particular, it is illustrated that the CNT-based irradiator includes a plurality of CNT-based cathodes 1104, and a plurality of anodic regions 1106 defining a conical shape. More specifically, the anodic regions 1106 define horizontal segments within the conical shape 1107. The plurality of cathodes 1104 can emit electrons toward the anodic regions 1106 such that the correspondingly different electromagnetic waves from each of the anodic regions 1106 can be emitted in substantially same directions. Thus, for instance, the structure of a target can be irradiated at multiple depth levels for analysis relatively simultaneously. Indeed, using this technique, electromagnetic waves can be generated in all directions (360°) around the irradiator.

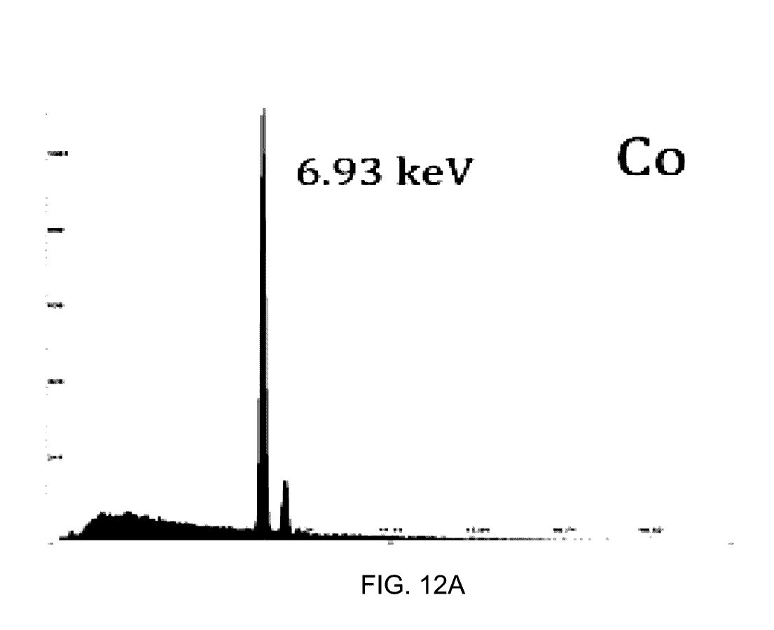

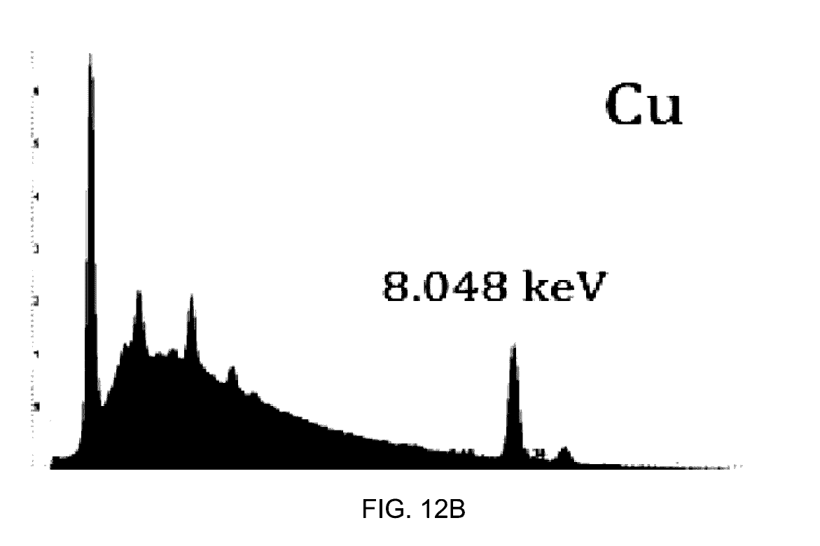

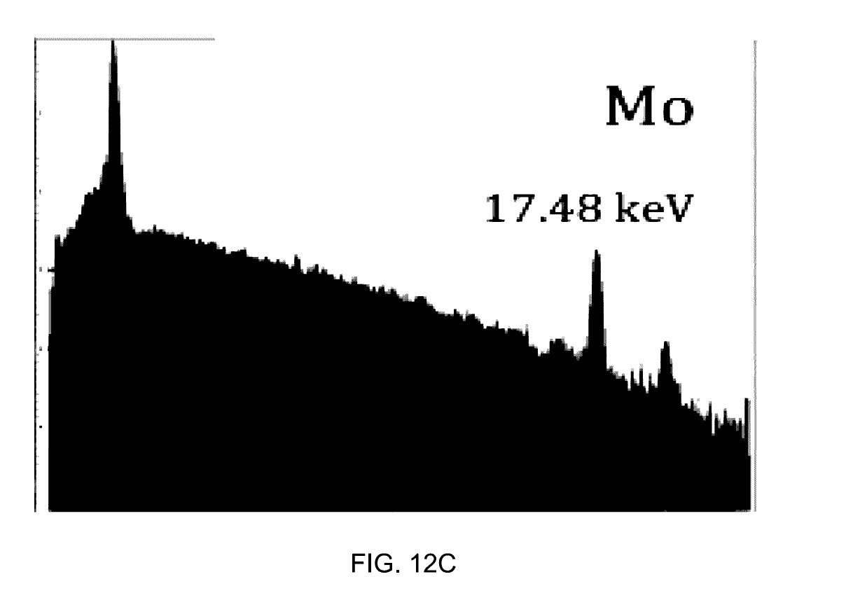

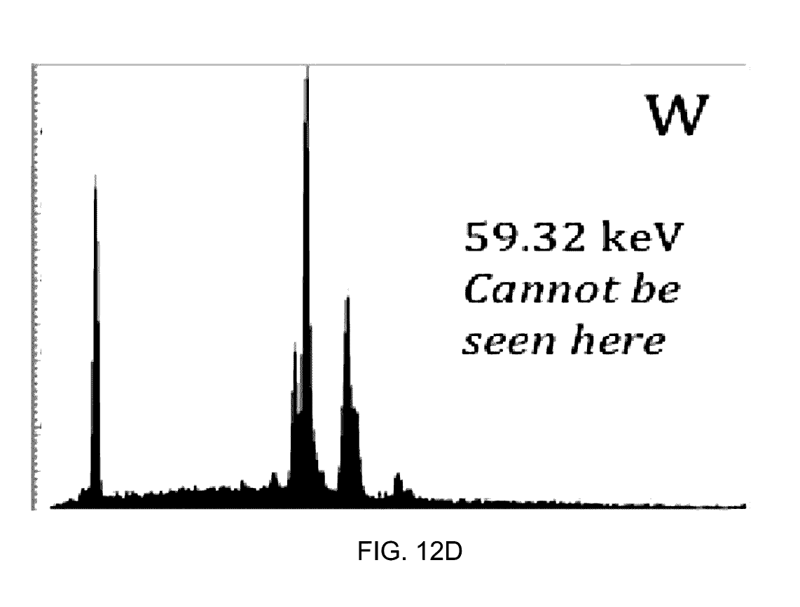

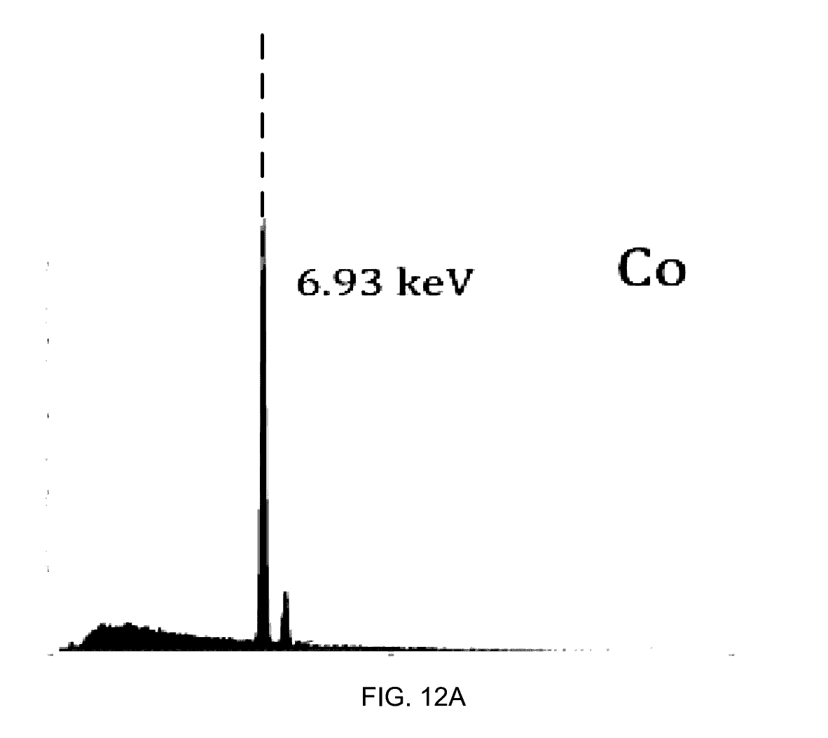

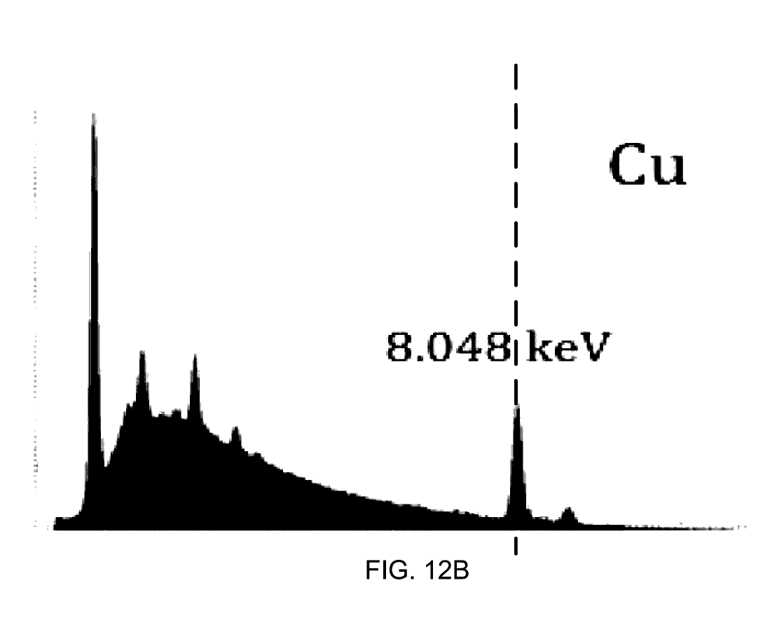

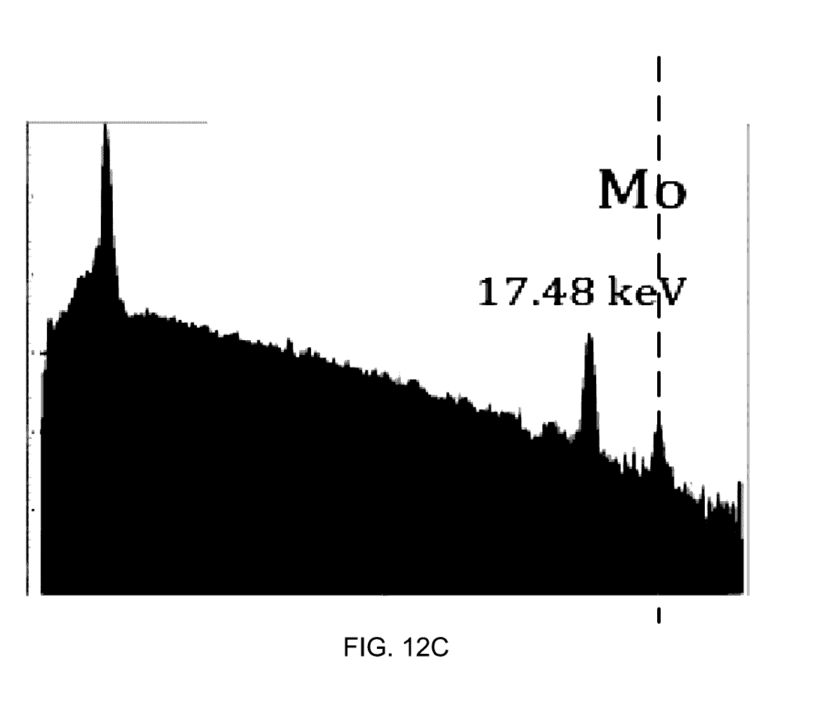

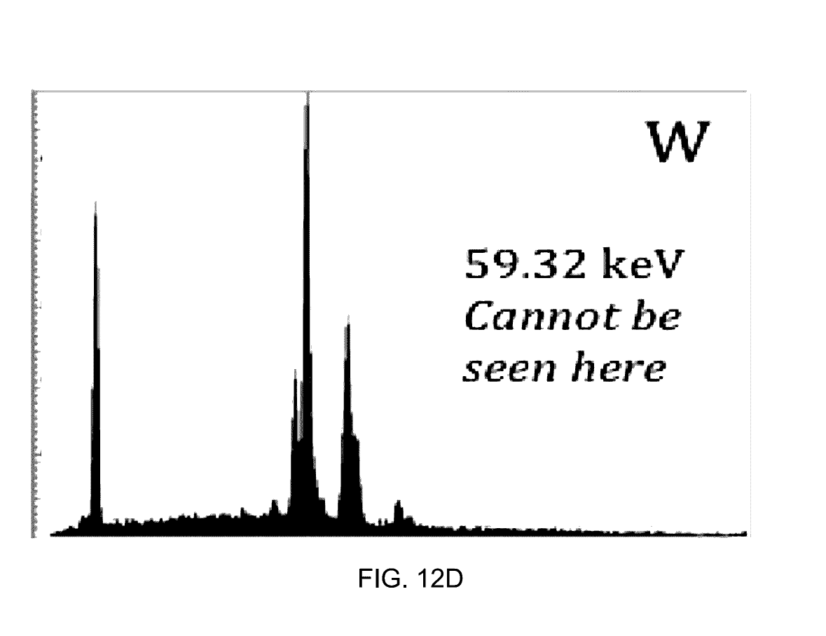

For reference, FIG. 12A-12D illustrate examples of distinctly different X-ray spectra that can be realized in accordance with embodiments of the invention. In particular, FIG. 12A illustrates an emission spectra corresponding with a cobalt anodic region; the characteristic K_{α} line is highlighted. FIG. 12B illustrates an emission spectra corresponding with a copper anodic region; the characteristic K_{α} line is highlighted. FIG. 12C illustrates an emission spectra corresponding with a molybdenum anodic region; the characteristic K_{α} line is highlighted. FIG. 12D illustrates an emission spectra corresponding with a tungsten anodic region; the characteristic K_{α} line is out of view.

Of course, it can be understood that the various details of the described CNT-based irradiators can be implemented in any of a variety of ways in accordance with embodiments of the invention. For example, the described structures can adopt any suitable height and diameter. In many embodiments, the irradiators have a height of approximately 2.5 inches. In a number of embodiments, the irradiators can have a diameter of approximately 1 inch. However, it should be appreciated that the disclosed irradiators can conform to any suitable length scale in accordance with embodiments of the invention. Similarly, the described irradiators can be made from any suitable materials. For instance, in some embodiments, the housing is made from stainless steel and Vespel® (a high dielectric plastic). In general, any suitable configuration that allows electrons emitted from a CNT-based cathode to be controllably directed toward a specific anodic region (each of a plurality of anodic regions corresponding with a different emission spectrum) can be implemented in accordance with embodiments of the invention.

Although the present invention has been described in certain specific aspects, many additional modifications and variations would be apparent to those skilled in the art. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A CNT-based irradiator comprising:
at least one CNT-based cathode, itself comprising:
a plurality of carbon nanotubes adjoined to a substrate;
a plurality of anodic regions;
wherein each anodic region is configured to emit a distinctly different class of photons in a direction away from the at least one cathode in response to a same reception of electrons;
wherein each of the plurality of anodic regions is operable to receive electrons emitted from at least one of said at least one CNT-based cathode; and
wherein each of the at least one CNT-based cathode and the plurality of anodic regions are disposed within a vacuum encasing.

2. The CNT-based irradiator of claim 1, wherein at least one of the plurality of anodic regions comprises one of: Copper, Cobalt, Molybdenum, Tungsten, Palladium, Tantalum, Platinum, and Gold.

3. The CNT-based irradiator of claim 1, wherein each of the plurality of anodic regions is configured to emit a distinctly different class of photons corresponding with the X-ray portion of the electromagnetic spectrum in a direction away from the at least one cathode in response to a same reception of electrons.

4. The CNT-based irradiator of claim 3, wherein each of the distinctly different classes of photons are distinctly different as measured by the respective characteristic K_{α} lines.

5. The CNT-based irradiator of claim 1, wherein the plurality of carbon nanotubes are in the form of bundles of carbon nanotubes that are between approximately 1 μm and approximately 2 μm in diameter and that are spaced apart at a distance of approximately 5 μm.

6. The CNT-based irradiator of claim 1, wherein the plurality of anodic regions define a contiguous anode.

7. The CNT-based irradiator of claim 6, wherein the contiguous anode is rotatable such that each of the plurality of anodic regions can be placed within the line of sight of at least one of said at least one CNT-based cathode.

8. The CNT-based irradiator of claim 7, wherein the plurality of anodic regions define a contiguous circular anode.

9. The CNT-based irradiator of claim 8, wherein the plurality of anodic regions define quadrants within the contiguous circular anode.

10. The CNT-based irradiator of claim 7, wherein the plurality of anodic regions define a pyramidal shape.

11. The CNT-based irradiator of claim 1, further comprising:
a first gate electrode configured to accelerate electrons emitted from at least one of said at least one CNT-based cathode; and
a second gate electrode configured to focus electrons emitted from at least one of said at least one CNT-based cathode relative to at least one of the plurality of anodic regions.

12. The CNT-based irradiator of claim 1, further comprising a beam steering device operable to steer electrons emitted from at least one of said at least one CNT-based cathode towards a selected one of the plurality anodic regions in a first mode and a selected different one of the plurality of anodic regions in a second mode.

13. The CNT-based irradiator of claim 12, wherein the beam steering device is in the form of focusing coils.

14. The CNT-based irradiator of claim 1, wherein the at least one CNT-based cathode is at least two CNT-based cathodes.

15. The CNT-based irradiator of claim 14, wherein each of the CNT-based cathodes is independently operable such that a first CNT-based cathode can be operating to emit electrons while a second CNT-based cathode is not emitting electrons.

16. The CNT-based irradiator of claim 14, wherein each of at least two CNT-based cathodes is operable to simultaneously emit electrons towards a different respective one of the plurality of anodic regions.

17. The CNT-based irradiator of claim 16, wherein the anodic regions are configured such that each of at least two anodic regions can emit a distinctly different class of photons in a same general direction in response to the reception of electrons.

18. The CNT-based irradiator of claim 14, wherein at least one anodic region is operable to emit a distinctly different class of photons causing the propagation of electromagnetic waves in a planar manner 360° outside of the vacuum encasing.

19. A CNT-based irradiator comprising:
at least one CNT-based cathode, itself comprising:
a plurality of carbon nanotubes adjoined to a substrate;
at least one anodic region comprising an alloy and thereby configured to generate multispectral output in response to the reception of electrons;
wherein at least one of the at least one anodic region is operable to receive electrons emitted from at least one of the at least one CNT-based cathode;
wherein the at least one CNT-based cathode and the at least one anodic region are disposed within a vacuum encasing.

20. The CNT-based irradiator of claim 19, wherein the at least one anodic region is operable to emit distinctly different classes of photons corresponding with the X-ray portion of the electromagnetic spectrum as determined by respective characteristic K_{α} lines.
